(19) United States
(12) Patent Application Publication
(10) Pub. No.: US 2023/0319487 A1
(43) Pub. Date: Oct. 5, 2023

(54) ACCESSORY FOR DIRECTIONAL MICROPHONE ASSEMBLIES FOR HEARING DEVICES

(71) Applicant: Starkey Laboratories, Inc., Eden Prairie, MN (US)

(72) Inventors: Kyle Walsh, Minneapolis, MN (US); David Alan Fabry, Eden Prairie, MN (US); Justin Barlow, Burnsville, MN (US); Justin Osmond, Eden Prairie, MN (US)

(21) Appl. No.: 17/657,395

(22) Filed: Mar. 31, 2022

(51) Int. Cl. H04R 25/00; H04R 1/04; H04R 1/32; H04R 3/00; G06F 3/16

(52) U.S. Cl. CPC H04R 25/402; H04R 25/554; H04R 1/04; H04R 1/326; H04R 3/00; G06F 3/165; H04R 2420/07; H04R 2430/01

(57) ABSTRACT

Disclosed herein, among other things, are systems, apparatus and methods for directional microphone accessories for hearing device applications. An apparatus includes a base, at least one strap configured to attach the base to a top portion of a seat back, and a pivoting mount configured to be attached to the base, the pivoting mount configured to hold a directional microphone assembly. The pivoting mount is further configured to maintain the directional microphone assembly in an approximately horizontal orientation independent of a recline angle of the seat back.

### TECHNICAL FIELD

This document relates generally to hearing device systems and more particularly to an accessory for directional microphone assemblies for hearing device applications.

### BACKGROUND

Examples of hearing devices, also referred to herein as hearing assistance devices or hearing instruments, include both prescriptive devices and non-prescriptive devices. Specific examples of hearing devices include, but are not limited to, ear-wearable devices such as hearing aids, headphones, assisted listening devices, and earbuds.

Hearing aids are used to assist patients suffering hearing loss by transmitting amplified sounds to ear canals. In one example, a hearing aid is worn in and/or around a patient's ear. Hearing aids may include processors and electronics that improve the listening experience for a specific wearer or in a specific acoustic environment. Hearing devices generally include the capability to wirelessly communicate with external devices.

In some acoustic environments such as inside vehicles, factors such as ambient conditions and incoming sounds from different directions can contribute to difficulty in speech understanding for hearing impaired persons with hearing devices. In such difficult acoustic environments, hearing devices may receive audio streams or data wirelessly from a transmitter or streamer of an assistive listening device (ALD) or directional microphone assembly. However, directional microphone assemblies may require a predominantly horizontal orientation to function properly. When operating or riding in a vehicle, it may be difficult for the hearing impaired person to maintain the directional microphone assembly in such a position.

Thus, there is a need in the art for improved accessories for directional microphone assemblies, or directional microphone accessories, for heating devices.

### SUMMARY

Disclosed herein, among other things, are systems, apparatus and methods for accessories for directional microphone accessories for hearing device applications. An apparatus includes a base, at least one strap configured to attach the base to a top portion of a seat back, and a pivoting mount configured to be attached to the base, the pivoting mount configured to hold a directional microphone assembly. The pivoting mount is further configured to maintain the directional microphone assembly in an approximately horizontal orientation independent of a recline angle of the seat back.

Various aspects of the present subject matter include a system including a hearing device, a directional microphone assembly configured to wirelessly communicate with the hearing device, and a directional microphone accessory. The directional microphone accessory includes a base, at least one strap configured to attach the base to a top portion of a seat back, and a pivoting mount configured to be attached to the base, the pivoting mount configured to hold the directional microphone assembly. The pivoting mount is further configured to maintain the directional microphone assembly in an approximately horizontal orientation independent of a recline angle of the seat back.

Various aspects of the present subject matter include a method for making a directional microphone accessory. The method includes providing a base, providing at least one strap configured to attach the base to a top portion of a seat back, and providing a pivoting mount configured to be attached to the base. The pivoting mount is configured to hold the directional microphone assembly, and the pivoting mount is further configured to maintain the directional microphone assembly in an approximately horizontal orientation independent of a recline angle of the seat back.

This Summary is an overview of some of the teachings of the present application and not intended to be an exclusive or exhaustive treatment of the present subject matter. Further details about the present subject matter are found in the detailed description and appended claims.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter,

FIG. 1A illustrates a block diagram of a system for wireless communication for hearing devices with external devices.

FIG. 1B illustrates a directional microphone assembly configured to wirelessly communicate with a hearing device.

FIG. 2A illustrates a directional microphone accessory for hearing device applications, according to an embodiment of the present subject matter.

FIG. 2B illustrates a base and pivoting mount for a directional microphone accessory, according to various embodiments of the present subject matter,

FIG. 2C illustrates the directional microphone accessory of FIG. 2A mounted on a seat back, according to an embodiment of the present subject matter.

FIG. 3A illustrates a directional microphone accessory including weighted flaps for heating device applications, according to an embodiment of the present subject matter.

FIG. 3B illustrates a directional microphone accessory including retention cords for hearing device applications, according to an embodiment of the present subject matter.

FIG. 4 illustrates a directional microphone accessory including a strap with mounting holes for hearing device applications, according to an embodiment of the present subject matter.

FIG. 5A illustrates a directional microphone accessory including at least one retractable hook for hearing device applications, according to an embodiment of the present subject matter.

FIG. 5B illustrates another view of the directional microphone accessory of FIG. 5A, according to an embodiment of the present subject matter.

FIG. 6 illustrates a flow diagram of a method of making a directional microphone accessory, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing devices generally, including ear-wearable devices including earbuds, headsets, headphones and hearing assistance devices using the example of hearing aids. Other hearing devices include, but are not limited to, those in this document. It is understood that their use in the description is intended to demonstrate the present subject matter, but not in a limited or exclusive or exhaustive sense.

In some acoustic environments such as inside vehicles, factors such as ambient conditions and incoming sounds from different directions can contribute to difficulty in speech understanding for hearing impaired persons with hearing devices. For example, in an automobile speech understanding can be difficult for hearing aid users. Conversational partners may be adjacent to the listener, in front or behind of the listener, or diagonal relative to the listener. There are also numerous potential sound sources that can create an unfavorable signal to noise ratio for the listener, such as own-car noise, road noise, other-car and traffic noise, radio noise, wind noise, etc. Hearing devices may include omnidirectional processing and noise reduction algorithms to assist in these noisy environments, but speech understanding can still be difficult.

In such difficult acoustic environments, hearing devices may receive audio streams or data wirelessly from a transmitter or streamer of an assistive listening device (ALD) or directional microphone assembly to assist in speech understanding. A directional microphone assembly, such as a table microphone, may include a 360-degree microphone array and can produce signal to noise ratios for a user that are superior to those produced by a hearing device alone. The directional microphone assembly is particularly adept at listening to different talkers at different directions relative to the hearing device user. However, directional microphone assemblies may require a predominantly horizontal orientation to function properly. When operating or riding in a vehicle, it may be difficult for the hearing impaired person to maintain the directional microphone assembly in such a position.

The present subject matter provides an accessory that allows use of a directional microphone assembly, such as a table microphone, in a vehicle. This accessory can attach to a passenger seat and function as a holder for the directional microphone assembly or table microphone. In one embodiment, the accessory is used to position the table microphone on a shoulder of a car passenger front seat, which places the microphone near the position of a talker's mouth in the vertical direction, and between talkers in the front and back seats.

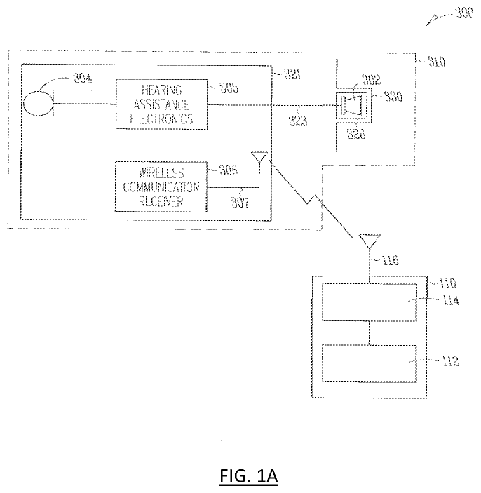

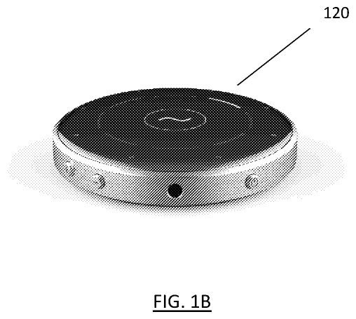

FIG. 1A illustrates a block diagram of a system for wireless communication for hearing devices with external devices. The system 300 shows an external device 110 (such as a table microphone 120 in FIG. 1B) in wireless communication with a hearing device 310. In various embodiments, the hearing device 310 includes a first housing 321, an acoustic receiver or speaker 302 in a second housing 328 positioned in or about the ear canal 330 of a wearer and conductors 323 coupling the speaker 302 to the first housing 321 and the electronics enclosed therein. The electronics enclosed in the first housing 321 include a microphone 304, hearing assistance electronics 305, a wireless communication receiver 306 and an antenna 307, in an embodiment. In various embodiments, the hearing assistance electronics 305 includes at least one processor and memory components. The memory components store program instructions for the at least one processor. The program instructions include functions allowing the processor and other components to process audio received by the microphone 304 and transmit processed audio signals to the speaker 302. The speaker 302 emits the processed audio signal as sound in the user's ear canal. In various embodiments, the hearing assistance electronics includes functionality to amplify, filter, limit, condition or a combination thereof, the sounds received using the microphone 304.

In the illustrated embodiment of FIG. 1A, the wireless communication receiver 306 is connected to the hearing assistance electronics 305 and the conductors 323 connect the hearing assistance electronics 305 and the speaker 302. In various embodiments, the external device 110 includes a streaming audio device such as a directional microphone assembly or table microphone, an assistive listening device (ALD), a programmer, a smartphone, a tablet, a personal computer, or other device capable of wireless communication. The external device 110 includes an antenna 116 connected to a radio circuit 114 that include a transmitter, in an embodiment. In various embodiments, the external device 110 includes one or more processors 112 or processing components. The external device 110 may also include one or more microphones and/or one or more speakers, in various embodiments.

FIG. 1B illustrates a directional microphone assembly, such as a table microphone 120, configured to wirelessly communicate with a hearing device. The table microphone 120 is a hearing accessory that creates improved signal to noise ratios for the listener, better than what hearing aids alone can achieve. The table microphone 120 includes a 360-degree microphone array that also has the advantage of not having to point an assistive listening device in the direction of the speaker or speakers. It is particularly adept at listening to different talkers at different directions relative to the hearing device user.

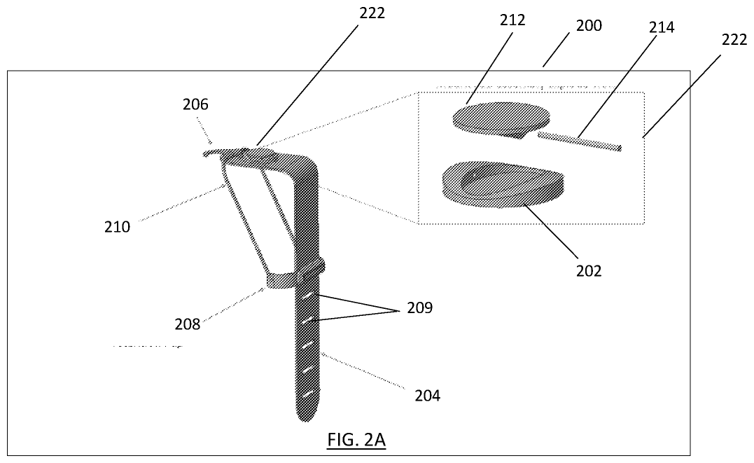

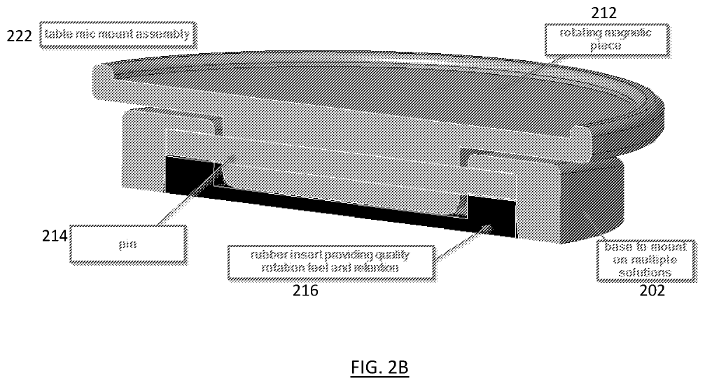

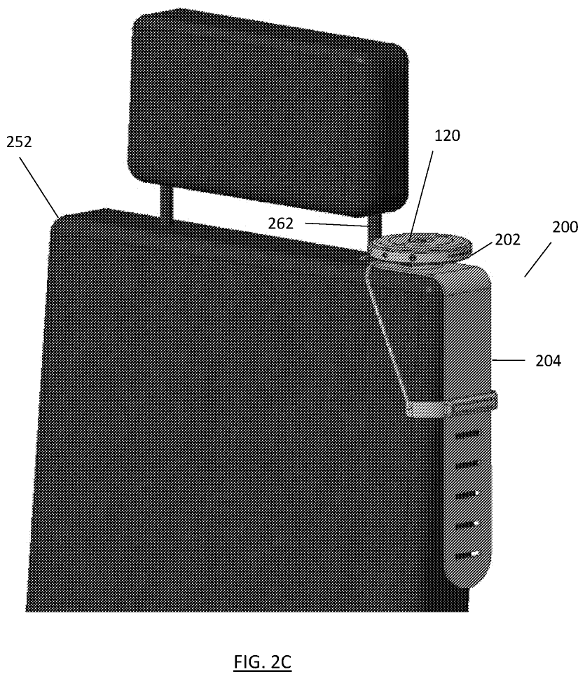

FIG. 2A illustrates a directional microphone accessory for hearing device applications, according to an embodiment of the present subject matter. In various embodiments of the accessory, an apparatus 200 includes a base 202 (further shown in an exploded view of the base/mount 222), at least one strap 204 configured to attach the base 202 to a top portion of a seat back, and a pivoting mount 212 configured to be attached to the base 202, the pivoting mount 212 configured to hold a directional microphone assembly. The pivoting mount 212 is further configured to maintain the directional microphone assembly in an approximately horizontal orientation independent of a recline angle of the seat back.

FIG. 2B illustrates a base and pivoting mount for a directional microphone accessory, according to various embodiments of the present subject matter. In one embodiment, the pivoting mount 212 includes a magnetic disc, such as a magnetic revolving disc for holding the directional microphone assembly (such as table microphone 120). In some embodiments, the pivoting mount 212 is configured to attach to the base 202 using a pin 214 configured to extend through at least a portion of the pivoting mount and the base. In some embodiments, a rubber insert 216 is provided for improving rotational feel and retention when the mount rotates relative to the base. Other types of mounts and connections to the base can be used without departing from the scope of the present subject matter. For example, in one embodiment the pivoting mount 212 includes a holder configured to retain the directional microphone assembly. In some embodiments, the holder includes a flexible material. In some embodiments, the holder includes a rigid material. In various embodiments, the holder includes cut outs on a side portion to provide access to power and volume buttons. The holder is configured to rotate with respect to the base, in various embodiments. In some embodiments, the holder includes an adhesive material to secure the directional microphone assembly.

According to various embodiments, the at least one strap 204 is configured to secure the base 202 to a medial (toward the midline of the car) shoulder of the seat back of a passenger seat. The passenger seat includes one of an automobile seat, a train seat, an aircraft seat, a spacecraft seat, or a watercraft seat, in various embodiments. In some embodiments, the at least one strap 204 includes a hook 206 configured to attach to a headrest post of the passenger seat. In various embodiments, the at least one strap 204 includes a buckle assembly 208 to accommodate multiple seat dimensions. In further embodiments, the at least one strap 204 includes multiple perforations 209 configured to receive a portion of the buckle assembly 208 to adjust a length of the at least one strap 204. In various embodiments, the directional microphone assembly 120 is configured to wirelessly connect to one or more hearing assistance devices. In various embodiments, the at least one strap 204 is configured to attach to an elastic cord 210 to secure the at least one strap to the seat back.

Various aspects of the present subject matter include a system including a hearing device, a directional microphone assembly configured to wirelessly communicate with the hearing device, and a directional microphone accessory. The directional microphone accessory includes a base, at least one strap configured to attach the base to a top portion of a seat back, and a pivoting mount configured to be attached to the base, the pivoting mount configured to hold the directional microphone assembly. The pivoting mount is further configured to maintain the directional microphone assembly in an approximately horizontal orientation independent of a recline angle of the seat back.

In some embodiments, the at least one strap 204 includes a saddle configured to fit over the top portion of the seat back. In one embodiment, the saddle includes two arms configured to flex outward to fit the saddle over the seat back, and the two arms configured to flex inward to hold the saddle in place. In various embodiments, the base 202 include a rubber insert. The at least one strap 204 includes a retractable portion, in various embodiments.

The present subject matter provides an apparatus designed for a hearing aid user to be able to use a directional microphone assembly, such as a table microphone 120, in a vehicle. A vehicle is not a convenient place to use a directional microphone assembly, and the apparatus of the present subject matter (referred to herein as a directional microphone accessory) allows a user to enjoy the benefits of the directional processing and noise reduction of the directional microphone assembly in this listening environment. FIG. 2C illustrates an embodiment of the directional microphone accessory of FIG. 2A mounted on a seat back 252, In the depicted embodiment, the directional microphone accessory (apparatus 200) is designed to attach to the medial shoulder of a front passenger car seat. The apparatus 200 includes a strap 204 that lays over the side of the passenger seat back 252, starting on the top of the shoulder of the seat and extending down the side of the seat. On the top side of the strap 204 is a magnetic disc, or pivoting mount 212 that serves as the attachment point for the directional microphone assembly. The pivoting mount 212 is removably attached to a base 202 and can pivot to allow the directional microphone assembly to remain in a predominantly horizontal orientation irrespective of the recline angle of the passenger seat.

The present apparatus 200 includes features that maintain its position on the car seat. The apparatus may include a hook 206 at the end of the strap closest to the table microphone that attaches to the headrest post 262 located closest to the driver of the vehicle. In various embodiments, on a portion of the strap that lays over the side of the passenger seat there is an adjustable buckle 208 that can accommodate various car seat size dimensions. The strap has several perforations 209, or openings in the strap material, into which the buckle can attach. In one embodiment, a shock cord 210 (or bungee cord) runs from the top of the strap near the headrest post 262 to the buckle 208. When the buckle 208 is pulled away from the headrest post and a retention flap portion of the buckle is inserted into one of the perforations 209, elastic tension is created that holds the apparatus 200 in place on the side of the passenger seat. In one embodiment, the strap 204 includes a thin, wide 10 inch long material such as plastic. Other sizes and types of material for the strap may be used without departing from the scope of the present subject matter. In various embodiments, the mount 212 and base 202 can rotate with respect to one another over an angular range to compensate for movement of the seat back, such as when the seat or seatback is moved or reclined. The rotating may be uniaxial or multiaxial, in various embodiments.

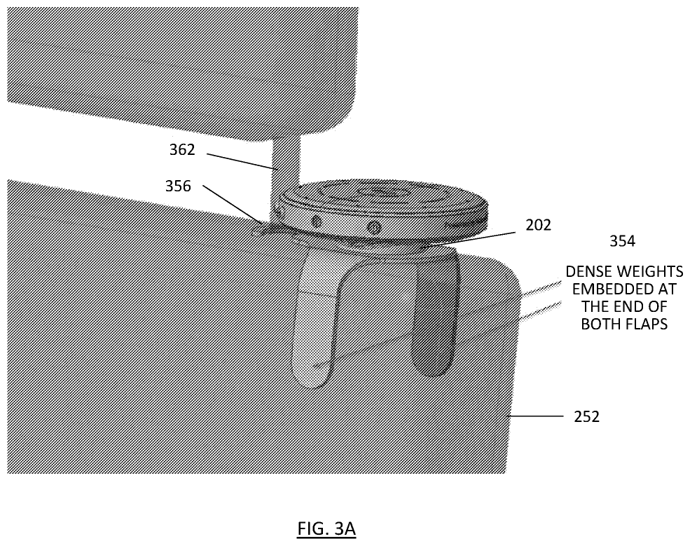

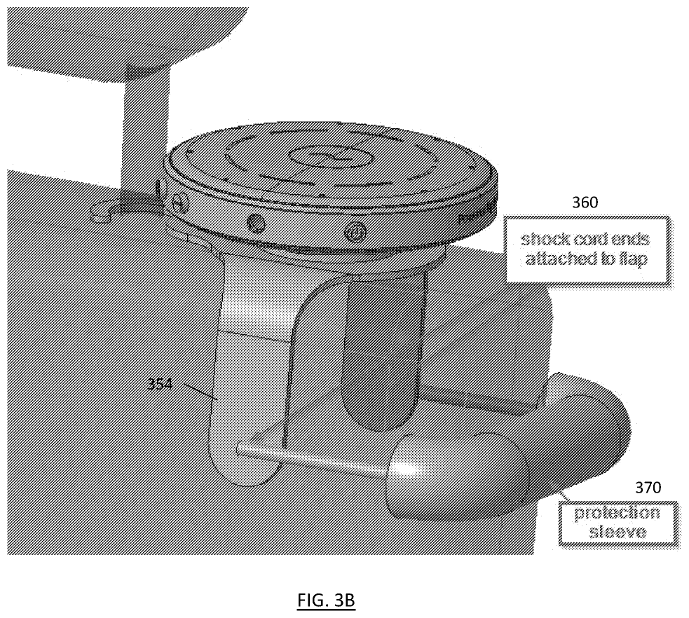

FIG. 3A illustrates a directional microphone accessory including weighted flaps 354 for hearing device applications, according to an embodiment of the present subject matter. In some embodiments, the flaps 354 or arms are configured to fit over the top portion of the seat back and maintain the base in place on a top portion of the seat back, forming a saddle. The flaps 354 include dense weights embedded or attached to an end portion of both flaps 354, in various embodiments. In other embodiments, the flaps 354 or aims flex outward for the user to fit the accessory over the car seat, then flex inward to hold the saddle securely in place, which may alleviate the need for weights in the flaps. In one embodiment, a hook 356 is included to attach to the headrest post 362 to assist in maintaining the base in place. On top of the saddle is a holder or receptacle for the table microphone, also referred to herein as a mount. In various embodiments, the holder includes a bottom and sides for retention of the table microphone, but has an open top so as to not cover the microphones on the table microphone. The holder may be made of flexible material (e.g., silicone) for ease of insertion and removal of the table microphone, or maybe made of rigid material such that the table microphone can slide in and out when oriented parallel to the holder. The holder may have cut-outs on the side to expose the power and volume buttons, as well as the charging port (such as a micro USB port) and audio output port (such as 3.5-mm port). The holder may spin on top of the saddle in 360 degrees so that the controls on the side of the table microphone may face the user whether they are driving, in the passenger seat, or in the back seat(s), in various embodiments.

In various embodiments, the mount includes a magnet instead of or in addition to the holder described above. In these embodiments, the directional microphone assembly or table microphone attaches to the saddle or strap with the magnet on the bottom of the table microphone, which is used in the non-primary use case of attaching the table microphone to a lanyard to be worn as a remote microphone. In one embodiment, the edges of the saddle hanging over the front and back of the car seat include sewn-in weights for stability.

In various embodiments, the present apparatus includes a portion that attaches to the headrest's medial post with a clasp, or with a ring through which the post is threaded. The apparatus also includes a magnet to which the table microphone attaches, in various embodiments. When the headrest is in its lowest position, the headrest and the weight of the device prevents spinning of the apparatus and holds the table microphone in the desired location.

In various embodiments, the table microphone attaches to a mounting subassembly that can pivot to maintain the table microphone in the horizontal orientation to ensure optimum performance. In various embodiments, the mounting subassembly may be capable of self-leveling. Specifically, the mounting fixture may be configured with a center of gravity or a center of buoyancy sufficient to keep the desired horizontal orientation of the table microphone. Thus, the mounting fixture may automatically be self-seeking a physical horizontal planar orientation because of its mechanical design. Examples of such a mounting configuration that may be used for the present apparatus include: rotation (such as a partial ball and socket bearing, wherein the ball component freely rotates within the mating cup/socket), levitation (such as magnetic), suspension/hanging (such as by cords attached to the table microphone and to suitably positioned fixed points), flotation in a fluid, use of a gyroscope, and/or other configuration with the suitable influence of gravity and/or buoyancy.

Maintaining the table microphone in a horizontal orientation is important for acoustic performance, but it also ensures that the automatic mode-switching mechanism of the table microphone is not engaged. When rotated away from the horizontal orientation, the table microphone may switch into a listening mode that uses only the upward most microphone under the assumption that the table microphone is being used as a neck-worn remote microphone. In various embodiments, an alternative to a manual or automatic solution to prevent mode switching through a mechanical design may be to disable the automatic mode switching when the table microphone is used in a car, such as by using a setting (such as activating a switch on the table microphone), or with a sensor (e.g., using a motion sensor (such as an inertial measurement unit or IMU)). The firmware of the table microphone may effectively disable the table microphone mode switching feature either (a) all the time in the case when a switch is set to disable the mode switching feature, or (b) only when the sensor indicates that the orientation of the table microphone is at or above the threshold level to trigger the mode switching, in various embodiments.

As stated above, the table microphone may be affixed to the medial shoulder of the front passenger seat using the apparatus of the present subject matter. Alternative embodiments may include: attaching the table microphone to a car seat using adhesive solutions like Velcro or tape, attaching the table microphone to a car seat using a strap, resting the table microphone on the center console, or affixing the table microphone to the ceiling of the car as the table microphone may work equally well in an inverted position as long as substantially horizontal.

FIG. 3B illustrates a directional microphone accessory including retention cords 360 for heating device applications, according to an embodiment of the present subject matter. In the depicted embodiment, which is similar to the embodiment of FIG. 3A, retention cords 360 are used to hold the flaps 354 in place on the seatback. In this embodiment, the flaps 354 may or may not have weights embedded or attached to the flaps. In one embodiment, an optional protection sleeve 370 is provided over the retention cords 360 to protect the surface of the seatback from abrasion caused by the retention or shock cord.

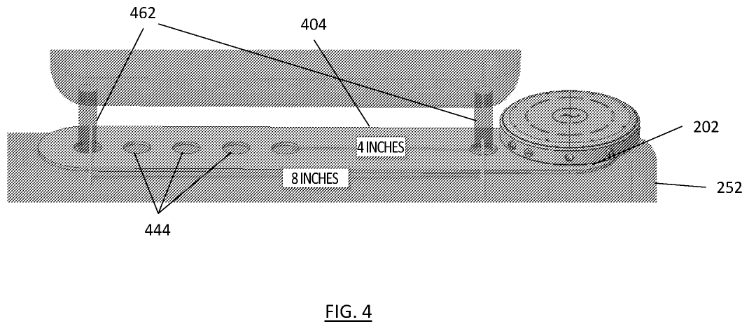

FIG. 4 illustrates a directional microphone accessory including a belt or strap 404 with mounting holes 444 for hearing device applications, according to an embodiment of the present subject matter. The mounting holes 444 are sized configured to accept headrest posts 462, in various embodiments, to secure the base 202 to the seatback 252. By providing multiple mounting holes 444, the strap 404 can be used with headrest posts of a variety of spacings. In one embodiment, the strap 404 includes mounting holes 444 that can accommodate headrest posts 462 of spacings varying from four to eight inches between adjacent headrest posts 462. Other headrest post spacings can be accommodated by adding additional mounting holes for various applications.

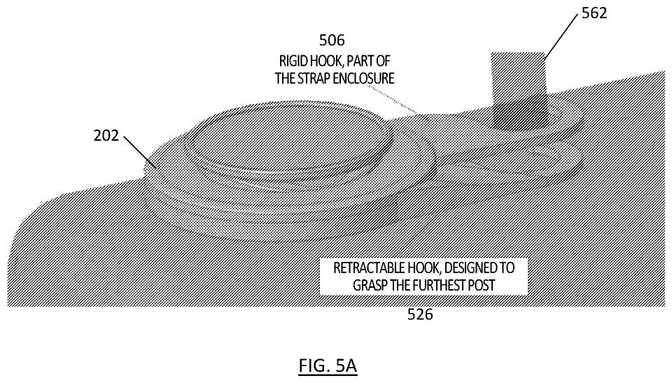

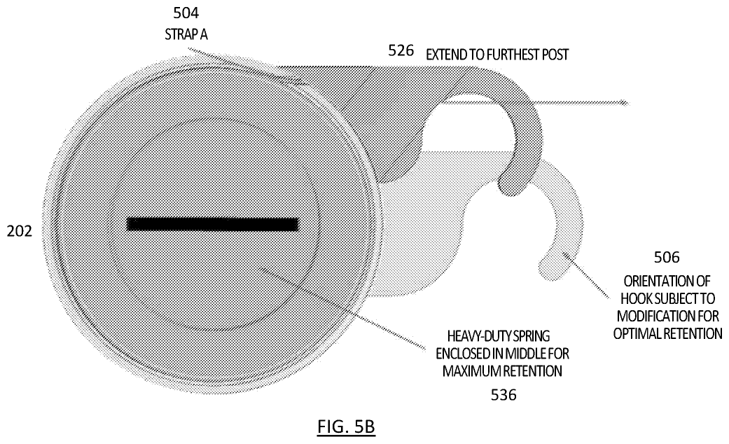

FIG. 5A illustrates a directional microphone accessory including at least one retractable hook 526 for hearing device applications, according to an embodiment of the present subject matter. In the depicted embodiment, the base 202 is attached to two hooks, a first hook 506 that is configured to attach to a first headrest post 562 closest the base, and a second retractable hook 526 that is configured to attach to a second headrest post furthest from the base (not shown).

FIG. 5B illustrates another view of the directional microphone accessory of FIG. 5A, according to an embodiment of the present subject matter. In one embodiment, a heavy duty spring 536 is included within the base 202 to provide for retraction and retention of the retractable hook 526. In various embodiments, one or more of the hooks 506, 526 are attached to or integrated with a strap 504. The orientation of the one or more hooks 506, 526 can be modified to provide for retention to the headrest posts and seatback, in various embodiments.

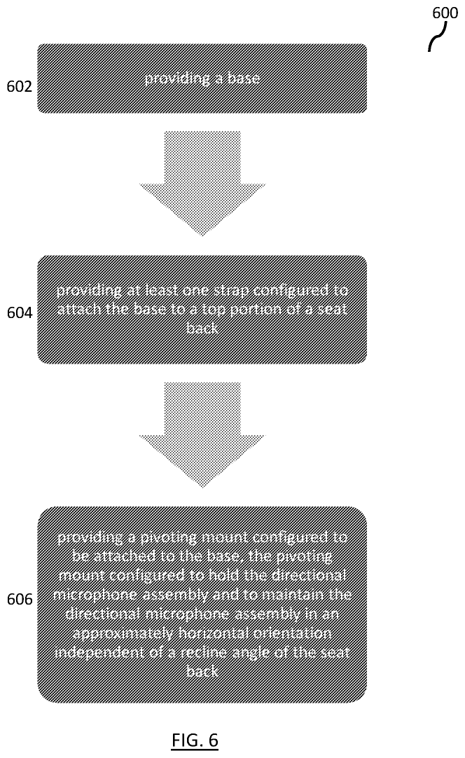

FIG. 6 illustrates a flow diagram of a method of making a directional microphone accessory, according to various embodiments of the present subject matter. The method 600 includes providing a base at step 602, providing at least one strap configured to attach the base to a top portion of a seat back at step 604, and providing a pivoting mount configured to be attached to the base at step 606. The pivoting mount is configured to hold the directional microphone assembly, and the pivoting mount is further configured to maintain the directional microphone assembly in an approximately horizontal orientation independent of a recline angle of the seat back.

The present subject matter provides a variety of benefits to a hearing device user, including providing improved speech understanding in problematic acoustic environments, such as vehicles. In addition, the apparatus of the present subject matter provides for hands-free operation of a hearing device accessory (such as a directional microphone assembly), which is critical especially when the hearing device user/listener is driving or operating the vehicle. The system, apparatus and method of the present subject matter is also configured to maintain a proper working orientation of the hearing device accessory, such as in a substantially horizontal orientation in the case of a table microphone. While adhesives or Velcro may be used in some embodiments, other embodiments provide for reliable retention of the directional microphone assembly that can be mounted on a temporary basis, without defacing or damaging the mounting location, and can be moved from vehicle to vehicle with relative ease. While the subject matter has been demonstrated for mounting to seat backs and headrest posts, other mounting locations can be used without departing from the scope of the present subject matter. For example, the present subject matter can be used to affix the directional microphone assembly (or other ALD) to a ceiling, floor, window ledge, dash, center console, or other location within a vehicle.

Various embodiments of the present subject matter support wireless communications with a hearing device. In various embodiments the wireless communications may include standard or nonstandard communications. Some examples of standard wireless communications include link protocols including, but not limited to, Bluetooth™, Bluetooth™ Low Energy (BLE), IEEE 802.11(wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications while others support NFMI. Although the present system is demonstrated as a radio system, it is possible that other forms of wireless communications may be used such as ultrasonic, optical, infrared, and others. It is understood that the standards which may be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

Hearing assistance devices typically include at least one enclosure or housing, a microphone, hearing assistance device electronics including processing electronics, and a speaker or “receiver.” Hearing assistance devices may include a power source, such as a battery. In various embodiments, the battery is rechargeable. In various embodiments multiple energy sources are employed. It is understood that in various embodiments the microphone is optional. It is understood that in various embodiments the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains may be employed to adjust the hearing assistance device output to a wearer's particular hearing impairment. The processor may be a digital signal processor (DSP), microprocessor, microcontroller, other digital logic; or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments of the present subject matter the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments of the present subject matter, different realizations of the block diagrams, circuits, and processes set forth herein may be created by one of skill in the art without departing from the scope of the present subject matter.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer.

The present subject matter is demonstrated for hearing devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices may include devices that reside substantially behind the ear or over the ear. Such devices may include hearing assistance devices with receivers associated with the electronics portion of the behind-the-ear device, or hearing assistance devices of the type having receivers in the ear canal of the user, including but not limited to receiver-in-canal (RIC) or receiver-in-the-ear (RITE) designs. The present subject matter may also be used in hearing assistance devices generally, such as cochlear implant type hearing devices. The present subject matter may also be used in deep insertion devices having a transducer, such as a receiver or microphone. The present subject matter may be used in bone conduction hearing devices, in some embodiments. The present subject matter may be used in devices whether such devices are standard or custom fit and whether they provide an open or an occlusive design. It is understood that other hearing devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. An apparatus, comprising:
a base;
at least one strap configured to attach the base to a top portion of a seat back; and
a pivoting mount configured to be attached to the base, the pivoting mount configured to hold a directional microphone assembly, the pivoting mount further configured to maintain the directional microphone assembly in an approximately horizontal orientation independent of a recline angle of the seat back.

2. The apparatus of claim 1, wherein the pivoting mount includes a magnetic disc.

3. The apparatus of claim 1, wherein the pivoting mount includes a holder configured to retain the directional microphone assembly.

4. The apparatus of claim 3, wherein the holder includes a flexible material.

5. The apparatus of claim 3, wherein the holder includes a rigid material.

6. The apparatus of claim 3, wherein the holder includes cut outs on a side portion to provide access to power and volume buttons.

7. The apparatus of claim 3, wherein the holder is configured to rotate with respect to the base.

8. The apparatus of claim 1, wherein the pivoting mount is configured to attach to the base using a pin configured to extend through at least a portion of the pivoting mount and the base.

9. The apparatus of claim 1, wherein the at least one strap is configured to secure the base to a medial shoulder of the seat back of a passenger seat.

10. The apparatus of claim 9, wherein the passenger seat includes one of an automobile seat, a train seat, an aircraft seat, a spacecraft seat, or a watercraft seat.

11. The apparatus of claim 9, wherein the at least one strap includes a hook configured to attach to a headrest post of the passenger seat.

12. The apparatus of claim 1, wherein the at least one strap includes a buckle assembly to accommodate multiple seat dimensions.

13. The apparatus of claim 12, wherein the at least one strap includes multiple perforations configured to receive a portion of the buckle assembly to adjust a length of the at least one strap.

14. The apparatus of claim 1, wherein the directional microphone assembly is configured to wirelessly connect to one or more hearing assistance devices.

15. A system, comprising:
a hearing device;
a directional microphone assembly configured to wirelessly communicate with the hearing device; and
a directional microphone accessory including:
a base;
at least one strap configured to attach the base to a top portion of a seat back; and
a pivoting mount configured to be attached to the base, the pivoting mount configured to hold the directional microphone assembly, the pivoting mount further configured to maintain the directional microphone assembly in an approximately horizontal orientation independent of a recline angle of the seat back.

16. The system of claim 15, wherein the at least one strap is configured to attach to an elastic cord to secure the at least one strap to the seat back.

17. The system of claim 15, wherein the at least one strap includes a saddle configured to fit over the top portion of the seat back.

18. The system of claim 17, wherein the saddle includes two arms configured to flex outward to fit the saddle over the seat back, and the two arms configured to flex inward to hold the saddle in place.

19. The system of claim 15, wherein the base include a rubber insert.

20. The system of claim 15, wherein the at least one strap includes a retractable portion.
